(19) United States
(12) Patent Application Publication
(10) Pub. No.: US 2011/0315024 A1
(43) Pub. Date: Dec. 29, 2011

(54) Casting Machine Valve, Dosing Chamber, and Casting Machine

(75) Inventors: Boris Ouriev, Niederuzwil (CH); Hannjo Boden, Detmold (DE); Bernhard Bauer, Oberuzwil (CH); Leo Bühler, Wadenswil (CH); Andreas Diener, Wuppertal (DE)

(73) Assignee: BÜHLER AG, Uzwil (CH)

(21) Appl. No.: 13/128,307

(22) PCT Filed: Oct. 21, 2009
(86) PCT No.: PCT/EP09/63800

§ 371 Date: Jun. 23, 2011

(30) Foreign Application Priority Data
Nov. 10, 2008 (DE) 10 2008 043 604.6

(51) Int. Cl. A23G 1/22; F16K 15/00

(52) U.S. Cl. 99/485; 137/511

(57) ABSTRACT

The invention relates to a casting machine valve (32, 42; 50; 60; 70; 80; 90; 100; 110; 120; 130), a pressure generating means (3, 4, 5, 6, 32, 42) for installation in a casting machine (1), and a casting machine (1) for casting a flowable mass, particularly a liquid mass having suspended solid particles, such as chocolate, wherein cocoa particles and sugar particles are typically suspended in a melted fat mass containing cocoa butter and more or less milk fat. The valve (50; 60; 70; 80; 90; 100; 110; 120) comprises a valve body (51; 61; 71; 81; 91; 101; 111; 121; 131) having a valve opening and at least one valve cap (53; 64; 76; 83; 94; 105; 115; 128; 133) that is associated with the valve opening, is hinged on the valve body, and closes the valve opening in the unpressurized state without preloading.

The invention relates to a casting machine valve, to a pressure generating means for installation in a casting machine and to a casting machine for casting a flowable mass, in particular a liquid mass with suspended solid particles, such as for example chocolate, in which typically cocoa particles and sugar particles are suspended in a molten fatty mass comprising cocoa butter and to a greater or lesser extent milk fat.

Known casting machines for casting chocolate include, for example, a mass container for receiving the flowable mass; at least one valve, which is in fluidic connection with the interior space of the mass container, the valve being in an open state when a pressure gradient is present along the flowing-through direction of the said valve and in a closed state when this pressure gradient is not present along the flowing-through direction of the said valve; and a pressure generating means for producing a pressure gradient along the flowing-through direction of the valve.

In practice, the component parts of such casting machines comprise rigid metal parts. The mass container serves for receiving the castable mass. Leading away from its base are lines, which respectively open out in a multiplicity of chambers, in each of which a piston can be moved. Each of the chambers is respectively connected at the other end to a nozzle. A valve function is provided for each chamber/piston/nozzle unit.

In an intake stroke, the respective valve opens the respective connecting line between the mass container and the respective chamber, while the respective connecting line between the respective chamber and the respective nozzle is blocked. The respective piston then moves in the chamber in such a way that the free chamber volume is increased and mass is sucked into the respective chamber.

In a discharge stroke, the respective valve closes the respective connecting line between the mass container and the respective chamber, while the respective connecting line between the respective chamber and the respective nozzle is opened. The respective piston then moves in the chamber in such a way that the free chamber volume is reduced and mass is pumped out of the respective chamber into the respective nozzle.

The mass emerging from the nozzle is then forced or poured onto an underlying surface or into a hollow mold.

In the case of some particlular designs of such casting machines, the valve function is coupled with the piston function. For this, the piston is formed, for example, as a substantially cylindrical reciprocating/rotary piston, which can perform in a cylinder chamber on the one hand a reciprocating movement along the axis of the chamber or of the piston and on the other hand a rotational movement about the axis of the chamber or of the piston. By a special arrangement of the ports of the connecting lines in the respective chamber wall and corresponding clearances and/or apertures in the respective piston, a complete casting cycle (intake+discharge) can be carried out by a succession of reciprocating and rotating movements of the respective piston in a first direction and an opposite, second direction.

Although it has been possible even in the case of the last-mentioned more compact designs of such casting machines for the number of movable parts to be reduced somewhat by combining the piston and valve functions, such conventional casting machines still have a large number of movable parts.

In addition, when casting masses of low viscosity, in many cases continued flowing from the nozzle cannot be prevented at the end of the discharge stroke. In the case of most applications in which chocolate mass is cast, the casting is performed at such high temperatures that at least the crystal modifications of the triglycerides, which melt at relatively low temperatures, are melted, so that the chocolate mass as a whole is in a state of quite low viscosity and continued flowing takes place at the nozzles.

Since generally small amounts are cast in each casting cycle, virtually the entire casting operation takes place in the transient (non-steady-state) mode. Apart from the aforementioned continued flowing and the metering deviations that are at least to some extent caused by this, the casting, which predominantly takes place in the transient range, also leads to structural changes in the mass. This can lead to impairments of the quality of the cast chocolate masses.

Furthermore, given prescribed production capacities (cycle frequency and metered amount per cycle), it is virtually impossible to influence the variation over time of the flow resistance that is dependent on the flow properties (viscosity) of chocolate mass to be cast and the geometrical boundary conditions.

The pressure difference at the nozzle must be sufficiently great to overcome the flow limit of the chocolate mass to be cast at the beginning of casting. As a result, this pressure difference increases strongly at first. As soon as the flowing begins, a much smaller pressure difference is required to maintain further constant flowing. In addition, owing to the laminar shearing flow which then flows, with a parabola like flow profile, there is a change in the flow properties (viscosity) of the chocolate mass, with the effect that the viscosity decreases. The shearing therefore has a thinning effect here. The pressure difference required at the beginning to overcome the flow limit of the chocolate mass is therefore much greater than the pressure difference required to maintain the flow after flowing has begun. However, the design of the pressure sources and the stability of many machine parts have to be based on this maximum pressure requirement.

The invention is therefore based on the object of providing a casting machine valve, a pressure generating means for installation in a casting machine and a casting machine for producing an edible product from a castable mass, in particular from a fatty mass, such as for example chocolate, with which the described disadvantages and inadequacies during casting can be avoided or at least reduced. At the same time, it is intended that the casting machine valve, the pressure generating means and the casting machine should have a structure that is simple and not susceptible to faults.

### Valve

The valve according to the invention is suitable for installation in a casting machine as described above. It has a valve body with a valve opening and at least one valve flap, which is assigned to the valve opening and is articulated on the valve body, the valve flap closing the valve opening in the pressureless state to the greatest extent without prestressing.

In its closed state, the valve flap lies against the valve body or against one or more valve flaps. This takes place without prestressing. That is to say that, without a load, no force is exerted between a valve flap and a further valve flap or between a valve flap and the valve body. In this case, the valve opening is closed to the greatest extent, in particular sealed, so that no mass can penetrate through the valve. The valve opening may be closed in such a way that the valve flaps also seal the valve opening for highly fluid mass. However, it is also sufficient if typical masses with suspended solid particles, such as fatty masses of rather low viscosity, are reliably held back.

The inherent stress of the valve flap, which is dictated for example by the elasticity of the valve flap material or the spring constant of a restoring spring, prevents the emergence of mass through the valve in an uncontrolled manner, i.e. taking place for example without a defined pressure difference at the valve, and in particular the continued flowing of mass at the end of a casting operation.

The inherent stress of the valve flap is preferably chosen such that it is adapted to the flow properties, for example the viscosity or surface tension of the mass, and/or to the dimensions of a metering chamber. Thus, the inherent stress is intended to ensure that the valve does not open already when there is a small load, for example under the pressure of the weight of the mass in the metering chamber.

The closing force of the valve can be increased by further measures, for example by the valve flaps being subjected to constant prestressing or by an additional force acting on the flaps during the closing phase. As soon as the valve is to be opened, the closing force can be reduced or removed.

Alternatively, the inherent stress may be so great that it is necessary to allow an additional force to act on the valve during the opening phase.

The additional force may be of a pneumatic, hydraulic, electromagnetic or mechanical nature.

For example, the valve flaps may alternatively and/or additionally be kept closed by a positive pressure or negative pressure, which acts only or predominantly during the closing phase.

The additional force may also be transferred to the valve flaps in the form of a preferably spring-loaded valve tappet.

The valve flaps may also be formed in such a way that they can be activated hydraulically or pneumatically.

The valve flaps may be formed in such a way that opening and/or closing is performed on the basis of the piezoelectric effect, for example by means of a piezoelectric actuator or by means of valve flaps which contain piezoelectric material.

Additional forces for closing and/or opening the valve flap, as described above, may also be applied in the case of valve flaps which are prestressed in the pressureless state.

Preferably, the valve is in an open state when a pressure gradient is present along the flowing-through direction of the said valve and in a closed state when this pressure gradient is not present along the flowing-through direction of the said valve.

Only when the pressure difference produced at the valve, preferably built up in a defined way, is great enough, are the closing force of the sealing valve flap and the flow limit of the mass to be forced through the valve opening overcome and the mass begins to flow through the valve opening, the valve flap being moved and the flow cross section of the valve increasing.

The closing function of the valve can also be improved if a plurality of valve flaps are arranged one after the other in the direction of flow. The valve only opens when the closing force of all the valve flaps is overcome. There may be, for example, two non-prestressed valve flaps or groups of valve flaps arranged one after the other.

During the casting operation, a momentary or steady-state equilibrium is established between the elastic restoring force, or the closing force, of the valve flap and the deflecting force (opening force) of the valve flap, produced by the pressure difference in the flowing mass. The “yielding” valve has the effect of preventing the momentary transient pressure peaks of the pressure difference present at the valve, or at least of keeping them down significantly in comparison with a rigid valve.

The pressure gradient for opening the valve flaps may be produced and/or increased, for example, by the weight of mass continuing to flow and/or by an additionally applied negative pressure or positive pressure.

The valve flap is preferably flexible. For this purpose, it consists of a sufficiently soft-elastic material and/or is sufficiently small along one dimension, i.e. has a small flap thickness. It is particularly advantageous if the valve flap consists of elastomer material. As a result, a good closing action of the valve can be achieved.

To improve the symmetry of the flow through the valve, at least two valve flaps assigned to the valve opening may be provided, articulated on the valve body and sealing the valve opening. Furthermore, the contribution to the opening of the valve is then shared between two valve flaps, which has the consequence that the deflecting and/or deforming of each one of the valve flaps is less. The material in the articulating region of the valve flaps on the valve body or the material of the valve flaps themselves is stressed to a lesser extent as a result, whereby the lifetime of the valves can be increased.

The valve flap according to the invention preferably has such a geometry that the flap edge of at least one valve flap of the valve, projected perpendicularly to the flowing-through direction of the valve onto a valve cross-sectional plane, extends from a first radially outer point of the valve cross-sectional plane over a radially central point of the valve cross-sectional plane to a second radially outer point of the valve cross-sectional plane. This angular or curved profile makes it possible to increase the pressing force of the valve flap or the flap edge against the valve opening or the opening edge, in that a radially inwardly directed force is made to act on the valve flap from each of the two radially outer points of the valve cross-sectional plane in the articulating region.

It is advantageous if the valve has at least three valve flaps assigned to the valve opening, articulated on the valve body in a peripheral region, the valve having a pyramidal shape which is elevated in the direction of the flowing-through direction of the valve and the pyramidal faces of which are respectively formed by a valve flap, so that between two respective pyramidal faces adjacent to one another there respectively extends a valve slit from a radially outer point to the radial center. This shape of the valve, elevated in the flowing-through direction, increases its ability to withstand flipping-over of the valve in the closed state if the fluid pressure downstream in the flowing-through direction of the valve is greater than the fluid pressure upstream in the flowing-through direction of the valve. On the other hand, only a relatively small deformation is required for each of the plurality of valve flaps to bring about sufficient opening of the valve. Such a valve may have three, four, five or six valve flaps and have a respectively three, four, five or six-faced pyramidal shape.

In the case of a particularly advantageous embodiment, the pyramidal faces, as seen from the tip of the pyramid, are each concavely shaped and formed by a respective concavely shaped valve flap, the concavity of which extends between the delimiting valve slits of the flap and the peripheral articulating region of the flap. These concave valve flaps form in their totality a multisided pyramid, the side faces of which, from a downstream view, are each formed as a concave facet. This contributes to the improved closing action, i.e. a more stable closed state of the valve.

Alternatively, pyramidal faces, as seen from the tip of the pyramid, may also each be convexly shaped and formed by a respective convexly shaped valve flap, the convexity of which extends between the delimiting valve slits of the flap and the peripheral articulating region of the flap.

The valve body and the at least one valve flap may be formed in one piece. They are preferably formed as a one-piece elastomer molding. As a result, the valve according to the invention can be produced in a molding operation, if appropriate with subsequent crosslinking, for example vulcanization.

Alternatively, the valve body and the at least one valve flap may be connected to one another by a form-locking and/or force-locking plug-in connection. In this case, it is advantageous if the valve body and/or the valve flap(s) consist(s) of flexible material. The inherent stress or the degree of flexibility of the valve may be determined by the modulus of elasticity and/or by the dimensions orthogonal to the bending line or bending plane of the portions of the valve or component parts of the valve, an increasing in the modulus of elasticity or an increase in the dimensioning reducing the flexibility and, conversely, a decrease in the modulus of elasticity or a decrease in the dimensioning increasing the flexibility. The valve body and/or the at least one valve flap may also be coupled to a stabilizing element or stiffening element. The stabilizing element or stiffening element expediently consists of a first material and the valve or the valve body and/or the at least one valve expediently consists of a second material, the modulus of elasticity of the first material being greater than the modulus of elasticity of the second material.

In the case of a preferred embodiment, the valve body is arranged in a valve seat which surrounds it in the manner of a ring and consists of the first material. The valve body, and if applicable the valve flaps, preferably consist of a soft-elastic material, while the ring-like valve seat consists of a hard-elastic material.

All the measures for stiffening or stabilizing the valve as a whole or portions or component parts thereof should in this case be arranged within a soft-elastic material or act on the valve from the valve seat, so that it is ensured that the regions of the valve that come into contact with one another during the closing of the valve, for example valve slits, can undergo the necessary deformation. Alternatively, the valve flaps may have a sealing lip.

The regions of the valve that come into contact with one another during closing therefore form sealing regions or the actual valve seal.

In the case of a further embodiment, on account of the deformation of the valve, during the transition from the closed state to the open state of the valve or during the transition from the open state to the closed state of the valve, the at least one valve passes through a pressure point at which the potential energy stored in the valve is at a maximum.

The valve flaps are preferably at first in a first state of equilibrium, in which they close the valve opening without prestressing. They can then go over into a second state of equilibrium, in which they in turn are without prestressing, but release the valve opening. Alternatively, the valve flaps may be under prestressing in the closed and/or open state. An actuator is preferably necessary to deflect the valve flaps out of the state of equilibrium.

The pressure point of maximum energy may be brought about, for example, by the valve undergoing during its bending from the closed state to the open state a compression along the bending line or bending plane that at first increases and then, after overcoming the pressure point, decreases. The maximum potential energy is then primarily in the form of compression energy. The deformation of the valve may be, for example, an eversion of a valve flap from a concave form of the valve flap to a convex form of the valve flap.

### Pressure Generating Means

The object on which the invention is based is also achieved by a pressure generating means for delivering a flowable mass (M), in particular a liquid mass with suspended solid particles, which comprises a valve as described above. The pressure generating means is suitable in particular for installation in a casting machine.

The pressure for delivering the masses may be generated in a wide variety of ways. The mass may be in a container that is in connection with a pressure source, for example a pressurized gas source, a ram, a membrane or a pressure screw, and, on account of a pressure, be driven directly through an outlet opening. Alternatively, the mass may also go at first into a metering chamber. According to the invention, when it is discharged, the mass passes through at least one valve as described above.

The object on which the invention is based is also achieved by a further pressure generating means which is suitable for installation in a casting machine as described above and has, in particular, at least one valve as described above. It has a metering chamber with variable chamber volume and with at least one metering chamber outlet valve and one metering chamber inlet valve, the metering chamber inlet valve being arranged in the fluidic connection between the mass container volume and the metering chamber volume.

At least one outlet valve and one inlet valve each have a valve body with a valve opening and at least one valve flap assigned to the valve opening, articulated on the valve body and sealing the respective valve opening.

According to the invention, the closing and/or opening behavior of the valves differs.

The valve flap of the inlet valve and the valve flap of the outlet valve have closing forces of different magnitudes.

In particular, the valve flap or flaps of the inlet valve and the valve flap or flaps of the outlet valve are subjected to prestressing of different magnitudes, pressing the valve flap against the valve opening.

Alternatively, the greater closing forces of the respective valves may be additionally produced by means of an external force, acting on the valve flaps only or predominantly during the closing phase.

In addition, it may be provided that the opening of the valve flaps is assisted by means of an additional force, acting only or predominantly during the opening phase.

The outlet valve closes off the casting machines from the surroundings, while the inlet valve forms the fluidic connection between the mass container and the metering chamber. While the inlet valve determines the metering accuracy of the metering chamber, the outlet valve provides the metering accuracy of the delivered mass and the prevention of contamination of the surroundings. Premature emergence and continued dripping of mass from the outlet valve are undesired. The closing requirement for the outlet valve is therefore generally greater than that for the inlet valve. The valve flap or the valve flaps of the outlet valve are therefore preferably subjected to greater prestressing than that/those of the inlet valve.

In the limiting case, the valve flap of at least one valve, preferably the inlet valve, may close the valve opening in the pressureless state without prestressing.

The pressure generating means is a pump, the operating mode of which has an intake stroke and a discharge stroke.

The metering chamber with variable chamber volume, the metering chamber outlet valve and the metering chamber inlet valve together form a metering unit. During an intake stroke, mass passes via the open inlet valve into the metering chamber with the outlet valve closed and, during a discharge stroke, mass passes via the open outlet valve out of the metering chamber with the inlet valve closed, in order for example to be poured into hollow molds, into cells or onto a conveyor belt.

The pressure generating means may have a mass container which can be hermetically sealed and communicates with a pressure source. As a result, the filling of the metering chamber with mass (metering in) can be performed, or at least assisted, by application of pressure to the mass in the mass container. A source of compressed gas, in particular a pressurized air source, may be used as the pressure source. Instead of the pressure source or in addition to it, the pressure generating means may have a mass container which can be hermetically sealed and has a variable mass container volume. This makes it possible to generate pressure in the mass container that brings about, or at least assists, the metering into the metering chamber by reducing the volume of the mass container.

The flowing-through direction of the at least one metering chamber outlet valve preferably extends from the metering chamber volume to the atmosphere surrounding the casting machine and the flowing-through direction of the metering chamber inlet valve preferably extends from the mass container volume to the metering chamber volume. As a result, a negative pressure can be generated by increasing the metering chamber volume in the metering chamber, so that the metering chamber outlet valve remains closed and the metering chamber inlet valve opens, whereby mass flows into the metering chamber until the pressure is equalized. By reducing the metering chamber volume, a positive pressure can be generated in the metering chamber, so that the metering chamber inlet valve closes and the metering chamber outlet valve opens, whereby mass flows out of the metering chamber until the pressure is equalized.

The metering chamber preferably has a plurality of metering chamber outlet valves and only one metering chamber inlet valve. Alternatively, the metering chamber may have a plurality of metering chamber outlet valves and a plurality of metering chamber inlet valves.

In particular, the number of metering chamber outlet valves and the number of metering chamber inlet valves of a metering chamber may be the same, each metering chamber outlet valve being expediently assigned one metering chamber inlet valve.

In the case of a particularly advantageous embodiment, the casting machine or its pressure generating means has a plurality of metering chambers, each metering chamber preferably having one metering chamber outlet valve and one metering chamber inlet valve. As a result, a multiplicity of metering chambers can be arranged such that they are connected in parallel in the casting machine, whereby a high throughput can be achieved. The respective chamber volumes of each of the metering chambers are preferably variable in a manner coupled to one another.

### Casting Machine

This object is achieved by a casting machine according to the invention, which comprises a mass container for receiving the flowable mass. The casting machine has at least one valve, which is in fluidic connection with the interior space of the mass container, the valve being in an open state when a pressure gradient is present along the flowing-through direction of the said valve and in a closed state when this pressure gradient is not present along the flowing-through direction of the said valve. The casting machine also comprises a pressure generating means for producing a pressure gradient along the flowing-through direction of the valve.

According to the invention, the valve is a casting machine valve, as described further above, which has a valve body with a valve opening and at least one valve flap assigned to the valve opening, articulated on the valve body and sealing the valve opening in the pressureless state without prestressing.

The object is also achieved by a casting machine with a pressure generating means as described further above.

Further advantages, features and application possibilities of the invention are provided by the description which now follows of exemplary embodiments of a casting machine, a pressure generating means and a valve on the basis of the drawing, in which

FIG. 1 shows an embodiment of a metering unit of the pressure generating means according to the invention in a first operating phase;

FIG. 2 shows the metering unit in a second operating phase;

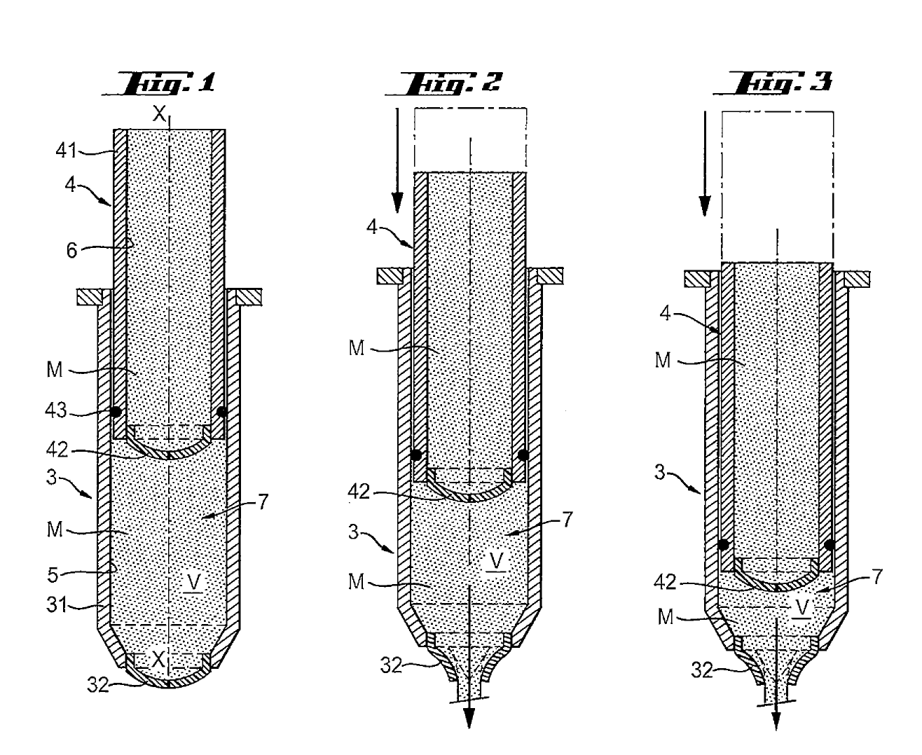

FIG. 3 shows the metering unit in a third operating phase;

FIG. 4 shows the metering unit in a fourth operating phase;

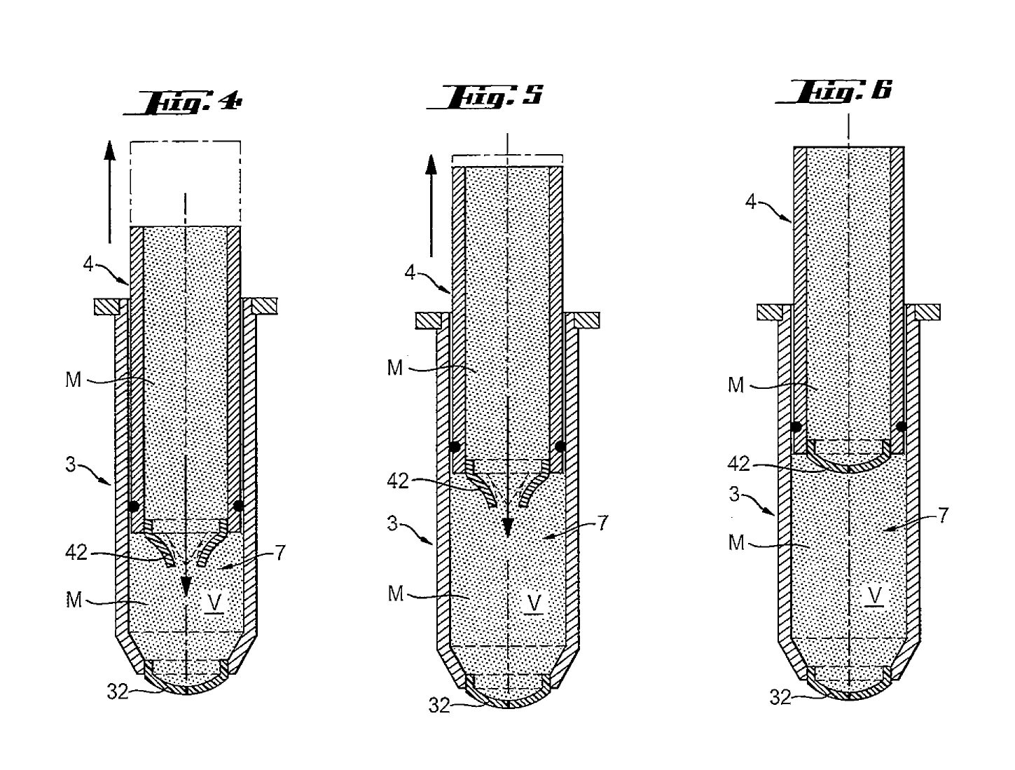

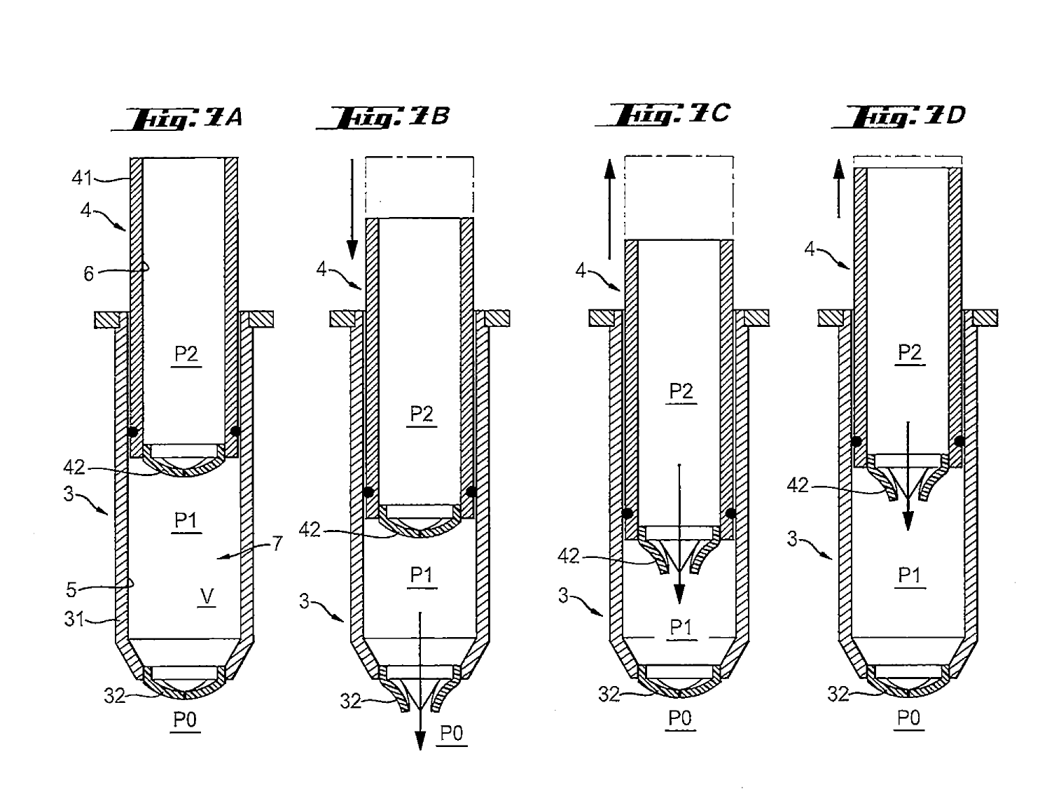

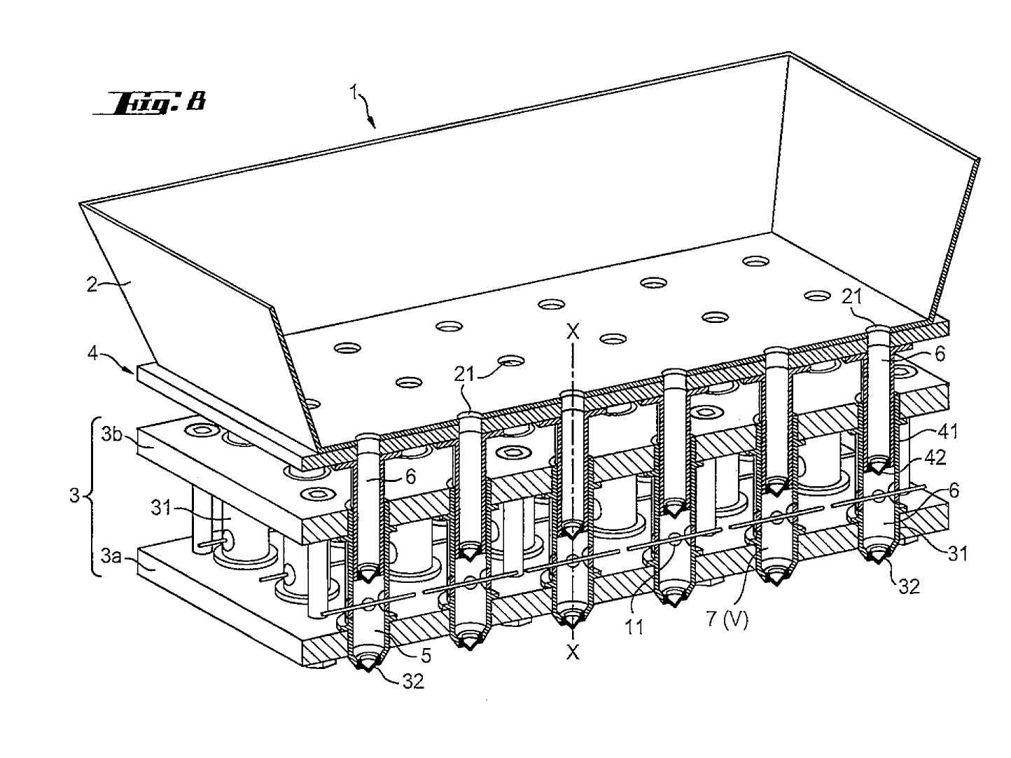

FIG. 5 shows the metering unit in a fifth operating phase;

FIG. 6 shows the metering unit in a sixth operating phase;

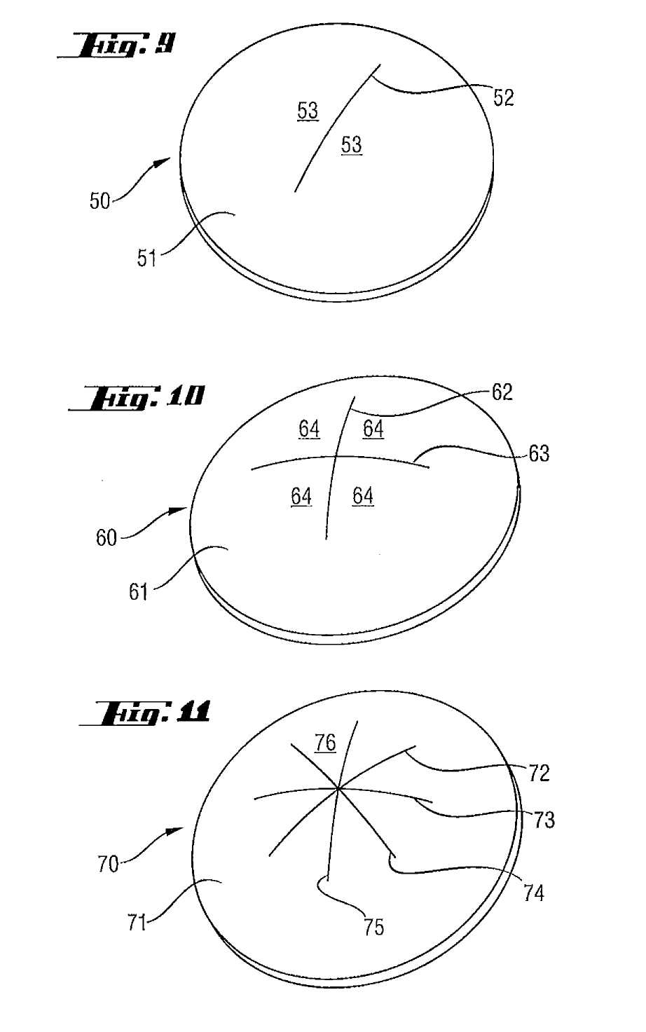

FIG. 7 shows on the basis of the metering unit the pressure conditions during the operation of the metering unit;

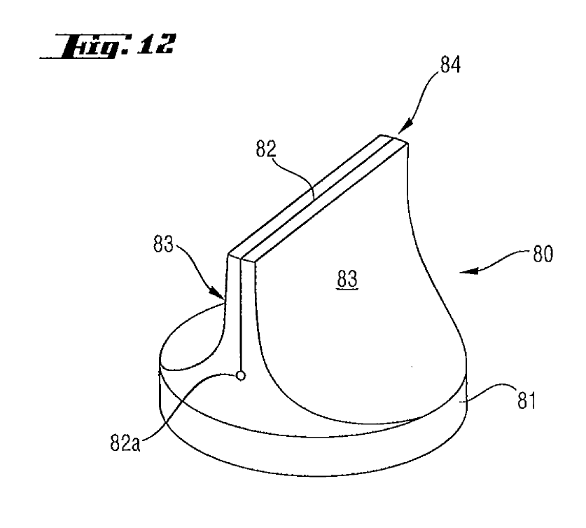

FIG. 8 shows a perspective view of a casting machine according to the invention shown in section along a vertical plane, the metering unit described in FIGS. 1 to 7 forming part of the pressure generating means or the casting machine;

FIG. 9 shows a perspective view of one embodiment of the valve according to the invention;

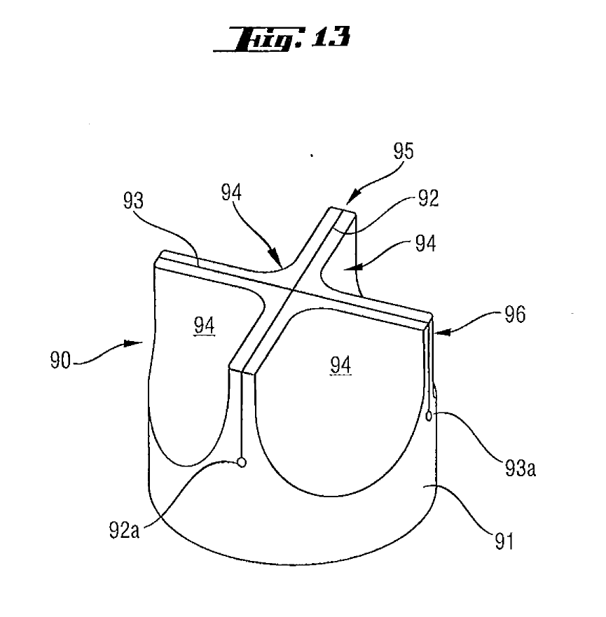

FIG. 10 shows a perspective view of a further embodiment of the valve according to the invention;

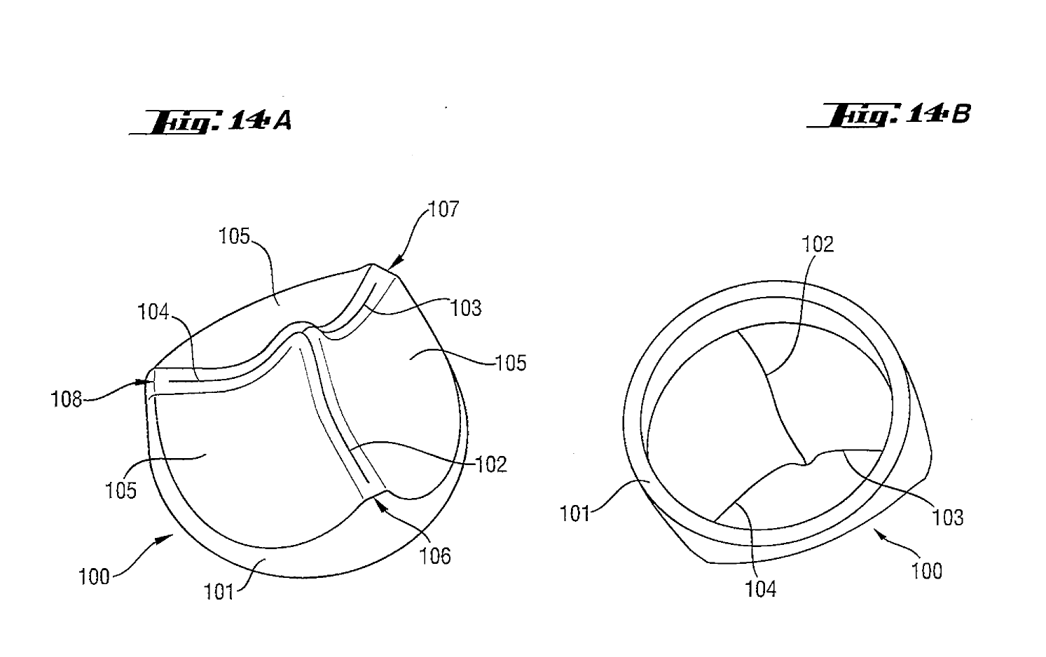

FIG. 11 shows a perspective view of a further embodiment of the valve according to the invention;

FIG. 12 shows a perspective view of a further embodiment of the valve according to the invention;

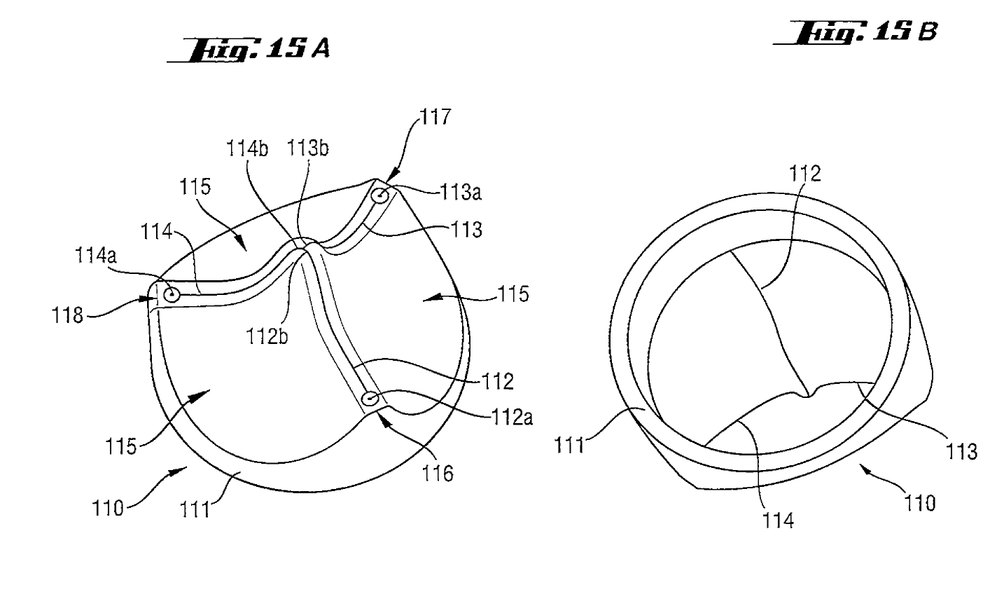

FIG. 13 shows a perspective view of a further embodiment of the valve according to the invention;

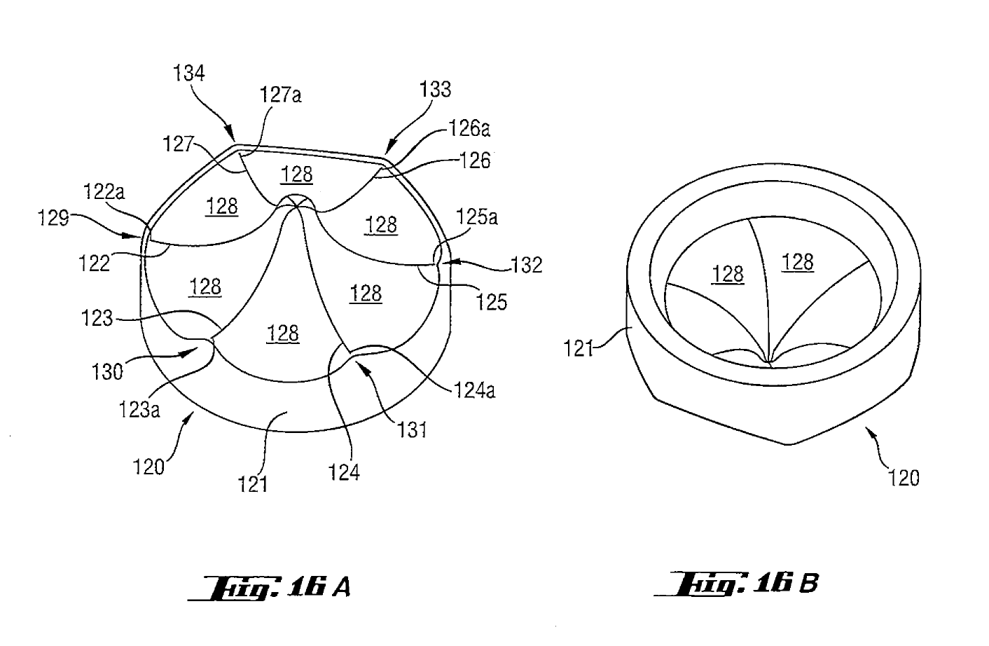

FIG. 14A shows a further embodiment of the valve according to the invention, seen substantially opposite to the flowing-through direction of the valve;

FIG. 14B shows the embodiment of the valve according to the invention as shown in FIG. 14A, seen substantially in the flowing-through direction of the valve;

FIG. 15A shows a further embodiment of the valve according to the invention, seen substantially opposite to the flowing-through direction of the valve; and

FIG. 15B shows the embodiment of the valve according to the invention as shown in FIG. 15A, seen substantially in the flowing-through direction of the valve;

FIG. 16A shows a further embodiment of the valve according to the invention, seen substantially opposite to the flowing-through direction of the valve; and

FIG. 16B shows the embodiment of the valve according to the invention as shown in FIG. 16A, seen substantially in the flowing-through direction of the valve;

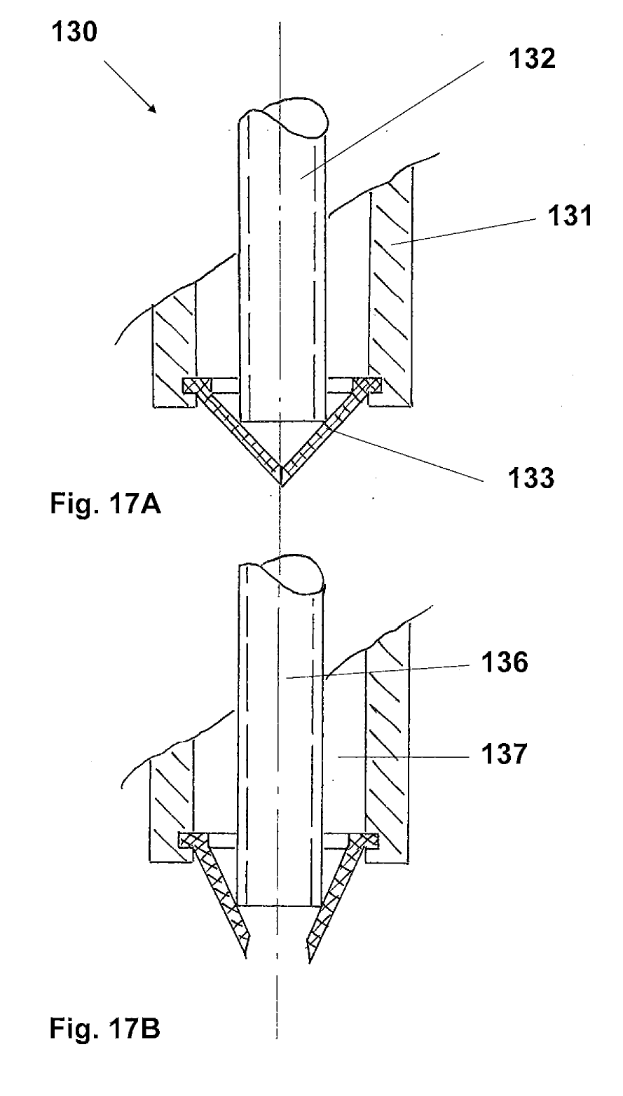

FIG. 17A shows a schematic sectional representation of a further embodiment of the valve according to the invention with the valve flaps closed; and

FIG. 17B shows a schematic sectional representation of a further embodiment of the valve according to the invention with the valve flaps open.

On the basis of FIG. 1, a description is now given of the structure of a metering unit 3, 4, which has a lower valve block 3 and an upper valve block 4. The metering unit 3, 4 is an essential component part of the pressure generating means according to the invention.

The lower valve block 3 contains a multiplicity of lower valve channels 5, which are arranged next to one another and parallel to one another and the cross section of which is preferably circular. Each of the lower valve channels 5 is delimited by a channel wall 31, which is preferably cylindrical. At the lower end of a lower valve channel 5 there is a lower valve 32, and at the upper end of a lower valve channel 5 there is an upper valve 42. The channel wall 31, the lower valve 32 and the upper valve 42 define a metering chamber 7, the volume V of which is variable and is formed by a variable portion of the lower valve channel 5.

The upper valve block 4 likewise contains a multiplicity of valve channels 6, which are arranged next to one another and parallel to one another and the cross section of which corresponds to the cross section of the lower valve channels 5, therefore is preferably likewise circular. Each of the lower valve channels 5 is delimited by a channel wall 31, which is preferably cylindrical. At the lower end of an upper valve channel 6 there is an upper valve 42, and at the upper end each upper valve channel 6 is connected to a mass container (see FIG. 8).

The channel wall 31, the lower valve 32 and the upper valve 42 determine the metering chamber 7 with its volume V. The inner cross section of a lower valve channel 5 corresponds to the outer cross section of an upper valve channel 6. Each lower valve channel 6 is displaceable inside a lower valve channel 5 along the common axis X of the channels 5 and 6. This relative movement of the channel wall 41 in relation to the channel wall 31 allows the volume V of the metering chamber 7 determined substantially by the channel wall 31, the lower valve 32 and the upper valve 42 to be changed. An annular seal 43, which is mounted as a sealing ring 43 in an annular groove in the outer surface of the channel wall 41, provides sealing of the metering chamber 7 and prevents castable mass from being able to spread between the channel wall 31 and the channel wall 41 and emerge in an uncontrolled manner from the metering chamber 7. The annular seal may also be formed as an annular bead (not represented) in one piece with the channel wall 41. Optionally, the plurality of axially spaced-apart sealing rings 43 or annular beads (not represented) may also be provided on the channel wall 41.

The lower valve 32 is formed from an elastic material. If there is a sufficiently small pressure difference between the metering chamber 7 and the surroundings (atmosphere) at the lower valve 32, i.e. if a minimum valve pressure difference is not exceeded, the elastic material of the valve remains substantially undeformed, and the lower valve 32 remains closed. Only if the minimum valve pressure difference is exceeded, does the lower valve 32 open.

A similar situation applies to the upper valve 42. The upper valve 42 is likewise formed from an elastic material. If there is a sufficiently small pressure difference between the valve channel 6 and the metering chamber 5 at the upper valve 42, i.e. if a minimum valve pressure difference is not exceeded, the elastic material of the valve remains substantially undeformed, and the upper valve 42 remains closed. Only if the minimum valve pressure difference is exceeded, does the upper valve 42 open.

The operating mode of the metering unit 3, 4 as a component part of the pressure generating means according to the invention is now described on the basis of FIGS. 1, 2, 3, 4, 5 and 6.

FIG. 1 shows the first phase of a casting cycle of the metering unit 3, 4. The upper valve block 4 or each of the upper valve channels 6 has been pulled out from the lower valve block 3 or from the respective lower valve channel 5 as far along the axis X as corresponds to the required metering volume. The upper valve block 4 is at the end of the intake stroke and is at rest with respect to the lower valve block 3. The volume V of the metering chamber 7 assumes its maximum value. Each upper valve channel 6 and each lower valve channel 5 is filled with castable mass M, which is sufficiently viscous that it comes to rest almost immediately after intake. This is at the same time the beginning of the discharge stroke. The lower valve 32 and the upper valve 42 are closed. The mass M is at rest.

FIG. 2 shows the second phase of the casting cycle. The valve block 4 or each of the upper valve channels 6 is pushed into the lower valve block 3 or into the respective lower valve channel 5 along the axis X. The upper valve 42 is closed, and the lower valve 32 is open. The mass M in the metering chamber 7 is discharged from the reducing volume V of the metering chamber through the lower valve 32. The upper valve block 4 is at a point within the discharge stroke and moving with respect to the lower valve block 3. Each upper valve channel 6 and each lower valve channel 5 is filled with mass M, which moves during the discharge stroke.

FIG. 3 shows the third phase of the casting cycle. The upper valve block 4 or each of the upper valve channels 6 has been pushed into the lower valve block 3 or into the respective lower valve channel 5 almost as far along the axis X as corresponds to the required metering volume. The upper valve 42 is closed, and the lower valve 32 is still open. The mass M in the metering chamber 7 continues to be discharged through the lower valve 32. The upper valve block 4 is just before the end of the discharge stroke and is still moving with respect to the lower valve block 3. The volume V of the metering chamber 7 has almost reached its minimum value. Each upper valve channel 6 and each lower valve channel 5 is filled with mass M.

FIG. 4 shows the fourth phase of the casting cycle. The upper valve block 4 or each of the upper valve channels 6 has been pulled out from the lower valve block 3 or from the respective lower valve channel 5 along the axis X. The upper valve 42 is open, and the lower valve 32 is closed. The mass M is sucked through the upper valve 42 into the increasing volume V of the metering chamber 7. The upper valve block 4 is at a point within the intake stroke and moving with respect to the lower valve block 3. The volume V of the metering chamber 7 is increasing. Each upper valve channel 6 and each lower valve channel 5 is filled with mass M, which moves during the intake stroke.

FIG. 5 shows the fifth phase of the casting cycle. The upper valve block 4 or each of the upper valve channels 6 has been pulled out from the lower valve block 3 or from the respective lower valve channel 5 as far along the axis X as corresponds to the required metering volume. The upper valve 42 is still open, and the lower valve 32 is still closed. The mass M continues to be sucked through the upper valve 42 into the increasing volume V of the metering chamber 7. The valve block 4 is just before the end of the intake stroke and still moving with respect to the lower valve block 3. The volume V of the metering chamber 7 has almost reached its maximum value. Each upper valve channel 6 and each lower valve channel 5 is filled with mass M.

FIG. 6 shows the sixth phase of the casting cycle of the metering unit 3, 4. The upper valve block 4 or each of the upper valve channels 6 has been pulled out from the lower valve block 3 or from the respective lower valve channel 5 as far along the axis X as corresponds to the required metering volume. The upper valve block 4 is at the end of the intake stroke and is at rest with respect to the lower valve block 3. The volume V of the metering chamber 7 again assumes its maximum value. Each upper valve channel 6 and each lower valve channel 5 is filled with mass M. This is at the same time the beginning of the discharge stroke (see FIG. 1). The lower valve 32 and the upper valve 42 are closed. The mass M is at rest.

The pressure conditions during the operation of the metering unit 3, 4 as a component part of the pressure generating means according to the invention are now described on the basis of FIGS. 7A, 7B, 7C and 7D.

FIG. 7A shows the pressure conditions at the end of the intake stroke or at the beginning of the discharge stroke. The upper valve block 4 is at rest with respect to the lower valve block 3. The mass M is likewise at rest. The pressure P1 in the metering chamber 7, formed by the lower valve channel 5, is equal to the pressure P2 in the upper valve channel 6 (P1 =P2). On account of the hydrostatic pressure, it may happen that the absolute values of the pressures P1 and P2 are somewhat higher than the atmospheric pressure P0. However, this pressure difference P1−P0=P2−P0 is less than the minimum valve pressure difference (opening pressure).

FIG. 7B shows the pressure conditions during the discharge stroke. The upper valve block 4 moves downward with respect to the lower valve block 3. The pressure P1 in the metering chamber 7, formed by the lower valve channel 5, is greater than the pressure P2 in the upper valve channel 6 (P1>P2). The upper valve 42 is closed. Furthermore, the pressure P1 in the metering chamber 7 is greater than the atmospheric pressure P0. The lower valve 32 is open.

FIG. 7C shows the pressure conditions during the intake stroke. The upper valve block 4 moves upward with respect to the lower valve block 3. The pressure P1 in the metering chamber 7, formed by the lower valve channel 5, is less than the pressure P2 in the upper valve channel 6 (P1<P2). The upper valve 42 is open. Furthermore, the pressure P1 in the metering chamber 7 is less than the atmospheric pressure P0. The lower valve 32 is closed.

FIG. 7D shows the pressure conditions toward the end of the intake stroke. The upper valve block 4 is still moving with respect to the lower valve block 3. The pressure P1 in the metering chamber 7 formed by the lower valve channel 5 is still less than the pressure P2 in the upper valve channel 6 (P1<P2). The upper valve 42 is still open. Furthermore, the pressure P1 in the metering chamber 7 is less than the atmospheric pressure P0. The lower valve 32 is still closed.

FIG. 8 shows a perspective view of a casting machine 1 shown in section along a vertical plane, the metering unit 3, 4 described in FIGS. 1 to 7 forming part of the casting machine 1. Arranged from top to bottom, the casting machine 1 contains substantially three elements, to be specific a mass container 2, an upper valve block 4 with upper valves 42 and a lower valve block 3 with lower valves 32.

The upper valve block 4 is formed here as a plate and is connected on its upper side to the mass container 2 and on its underside to a multiplicity of cylindrical upper valve channels 6, which respectively extend normal to the planar underside of the upper valve block 4 and are respectively formed by a cylindrical channel wall 41. At their lower end, they respectively have an upper valve 42. The base of the mass container 2 contains a multiplicity of holes 21, each of which opens out into one of the upper valve channels 6.

The lower valve block 3 is formed here by a lower plate 3a and an upper plate 3b, which are aligned parallel to the upper valve block 4 and the base of the mass container 2. The two plates 3a and 3b have a multiplicity of holes, at which they are connected via a multiplicity of cylindrical lower valve channels 5, which extend from the location of one of the holes in the plates 3a and 3b in the manner of webs between the lower plate 3a and the upper plate 3b and are respectively formed by a cylindrical channel wall 31. The lower valve block 3 consequently consists of a rigid unit, which is formed by the lower plate 3a, the upper plate 3b and a multiplicity of the web-like lower valve channels 5. At its lower end, each lower valve channel 5 has a lower valve 32.

The lower valve block 3 and the upper valve block 4 are mounted such that they slide on one another. The sliding mounting is in this case formed by the multiplicity of cylindrical channel walls 41 of the upper valve channels 6 and the multiplicity of cylindrical channel walls 31 of the lower valve channels 5, the outer wall of a respective valve channel wall 41 lying against the inner wall of a respective valve channel wall 31 and the concentric cylinder channel walls 31, 41 being able to slide in relation to one another along the respective cylinder axis X. This linear relative movement between the lower valve block 3 and the upper valve block 4 has the effect of changing the volume V of the metering chambers 7 substantially determined by the valve channel wall 31 as well as by the lower valve 32 and the upper valve 42, as can also be seen from the cycle of FIGS. 1, 2, 3, 4, 5 and 6. For the pressure conditions in the lower valve channel 5 or in that within a metering chamber 7 determined by it and in the upper valve channel 6, the same applies as stated with respect to FIGS. 7A, 7B, 7C and 7D.

For the essential functioning of the casting machine 1, it is irrelevant whether, during a casting cycle, the lower valve block 3 is moved and the upper valve block 4 is at rest or, conversely, whether both are moved simultaneously or one after the other in relation to one another.

In each of the metering chambers 7 there is a vibrating element 11, by which vibrations can be introduced into the mass to be cast. The vibrating elements 11 have the form of small rods which extend transversely through each metering chamber 7 or each lower valve channel 5 and are mounted in the valve channel wall 31.

FIG. 9 shows a perspective view of a valve 50 according to the invention. The valve 50 has a sheet-like main body 51 of an elastic material, in particular of elastomer material, with a circular outline, when viewed along the valve axis or the flowing-through direction of the valve. The main body 51 is convexly curved in the flowing-through direction of the valve and is penetrated by a slit 52, extending through the center point of the surface area of the valve 50. As a result, an approximately halfmoon-shaped valve flap 53 is respectively defined on both sides of the slit 52.

The valve 50 shown perspectively in FIG. 9 corresponds to the valves 32 and 42 shown in section in FIGS. 1 to 6.

FIG. 10 shows a perspective view of a further valve 60 according to the invention. The valve 60 has a sheet-like main body 61 of an elastic material, in particular of elastomer material, with a circular outline, as viewed along the valve axis or the flowing-through direction of the valve. The main body 61 is convexly curved in the flowing-through direction of the valve and is penetrated by a first slit 62, extending through the center point of the surface area of the valve 60, and a second slit 63, crossing the first slit at the center point of the surface area. The crossing slits 62 and 63 define a total of four valve flaps 64, which approximately have the form of a right-angled triangle.

The valve 60 shown perspectively in FIG. 10 also corresponds to the valves 32 and 42 shown in section in FIGS. 1 to 6.

FIG. 11 shows a perspective view of a further valve 70 according to the invention. The valve 70 has a sheet-like main body 71 of an elastic material, in particular of elastomer material, with a circular outline, as viewed along the valve axis or the flowing-through direction of the valve. The main body 71 is convexly curved in the flowing-through direction of the valve and is penetrated by four slits 72, 73, 74, 75, extending through the center point of the surface area of the valve 70 and crossing there. The crossing slits 72, 73, 74, 75 define a total of eight valve flaps 76, which approximately have the form of an acute-angled triangle.

Instead of the “straight” slits of the valves 50, 60 or 70 (see FIGS. 9, 10, 11), which only have the curvature of the sheet-like main body 51, 61, 71, the slits of the valves 50, 60, 70 may also have an additional curvature within the sheet-like main body 51, 61, 71. Advantageous are S-shaped slits (not shown), which are arranged in the main body 51, 61, 71 point-symmetrically in relation to the center point of the surface area (point of intersection of the valve axis and the sheet-like main body).

FIG. 12 shows a perspective view of a valve 80 according to the invention. The valve 80 has a main body 81 of an elastic material, in particular of elastomer material, with a circular outline, as viewed along the valve axis or the flowing-through direction of the valve. Protruding from the main body 81 in the flowing-through direction of the valve are two concavely curved valve flaps 83, which lie with their ends against one another along a transversely extending slit 82, and consequently form a slit ridge 84.

At the end 82a of the slit 82 there are accumulations of material; a hole with an approximately circular cross section is provided, extending through the membrane-like material of the valve 80 along the notch-like end 82a of the slit and thereby taking away from the end 82a of the slit its notch-like character, so that crack propagation caused by notch stresses in the membrane material of the valve 80 is prevented.

FIG. 13 shows a perspective view of a valve 90 according to the invention. The valve 90 has a main body 91 of an elastic material, in particular of elastomer material, with a circular outline, as viewed along the valve axis or the flowing-through direction of the valve. Protruding from the main body 91 in the flowing-through direction of the valve are four concavely curved valve flaps 94, which lie with their ends against one another along two slits 92, 93 extending transversely and crossing one another at right angles, and consequently forming two slit ridges 95, 96, which likewise cross one another at right angles.

At the end 92a, 93a of the slits 92, 93 toward the edges there are accumulations of material, provided to prevent crack formation starting from the ends 92a, 93a of the slits toward the edges. Instead of the accumulations of material or in combination with such accumulations of material, holes with an approximately circular cross section may be provided at the ends 92a, 93a of the slits toward the edges, extending through the membrane-like material of the valve 90 along the notch-like ends 92a, 93a of the slits and thereby taking away from the ends 92a, 93a of the slits their notch-like character, so that crack propagation caused by notch stresses in the membrane material of the valve 90 is prevented.

FIG. 14A and FIG. 14B show a perspective view of a valve 100 according to the invention, FIG. 14A being a view of the valve 100 as viewed substantially opposite to the flowing-through direction of the valve and FIG. 14B being a view of the valve 100 as viewed substantially in the flowing-through direction of the valve. The valve 100 has a main body 101 of an elastic material, in particular of elastomer material, with a circular outline, as viewed along the valve axis or the flowing-through direction of the valve. Protruding from the main body 101 in the flowing-through direction of the valve are three concavely curved valve flaps 105, which lie with their ends against one another along three slits 102, 103, 104, which are arranged in a star-like manner, converge at the center of the valve, and consequently form three slit ridges 106, 107, 108, which are likewise arranged in a star-like manner and converge at the center of the valve. The upper edge of the respective ridges 106, 107, 108 has a concave profile between the center of the valve and the edge of the valve. At the center of the valve, the converging upper edges of the ridges 106, 107, 108 protrude furthest upward from the base of the valve (imaginary plane defined by the lower edge of the valve main body 101).

FIG. 15A and FIG. 15B show a perspective view of a valve 110 according to the invention, FIG. 15A being a view of the valve 110 as viewed substantially opposite to the flowing-through direction of the valve and FIG. 15B being a view of the valve 110 as viewed substantially in the flowing-through direction of the valve. The valve 110 has a main body 111 of an elastic material, in particular of elastomer material, with a circular outline, as viewed along the valve axis or the flowing-through direction of the valve. Protruding from the main body 111 in the flowing-through direction of the valve are three concavely curved valve flaps 115, which lie with their ends against one another along three slits 112, 113, 114, which are arranged in a star-like manner, converge with their central ends 112b, 113b, 114b at the center of the valve, and consequently form three slit ridges 116, 117, 118, which are likewise arranged in a star-like manner and converge at the centre of the valve. The upper edge of the respective ridges 116, 117, 118 has a concave profile between the center of the valve and the edge of the valve. At the center of the valve, the converging upper edges of the ridges 116, 117, 118 protrude furthest upward from the base of the valve (imaginary plane defined by the lower edge of the valve main body 111).

At the end 112a, 113a, 114a of the slits 112, 113, 114 toward the edges there are accumulations of material, provided to prevent crack formation starting from the ends 112a, 113a, 114a of the slits toward the edges. Instead of the accumulations of material or in combination with such accumulations of material, holes with a circular cross section may be provided at the ends 112a, 113a, 114a of the slits toward the edges, extending through the membrane-like material of the valve 110 along the notch-like ends 112a, 113a, 114a of the slits and thereby taking away from the ends 112a, 113a, 114a of the slits their notch-like character, so that crack propagation caused by notch stresses in the membrane material of the valve 110 is prevented. The valve 110 is made to resemble a heart valve.

FIG. 16A and FIG. 16B show a perspective view of a valve 120 according to the invention, FIG. 16A being a view of the valve 120 as viewed substantially opposite to the flowing-through direction of the valve and FIG. 16B being a view of the valve 120 as viewed substantially in the flowing-through direction of the valve. The valve 120 has a main body 121 of an elastic material, in particular of elastomer material, with a circular outline, as viewed along the valve axis or the flowing-through direction of the valve. Protruding from the main body 121 in the flowing-through direction of the valve are six concavely curved valve flaps 128, which lie with their ends against one another along six slits 122, 123, 124, 125, 126, 127, which are arranged in a star-like manner, converge with their central ends at the center of the valve, and consequently form six slit ridges 129, 130, 131, 132, 133, 134, which are likewise arranged in a star-like manner and converge at the center of the valve. The upper edge of the respective ridges 129, 130, 131, 132, 133, 134 has a concave profile between the center of the valve and the edge of the valve. At the center of the valve, the converging upper edges of the ridges 129, 130, 131, 132, 133, 134 protrude furthest upward from the base of the valve (imaginary plane defined by the lower edge of the valve main body 121).

At the end 122a, 123a, 124a, 125a, 126a, 127a of the slits 122, 123, 124, 125, 126, 127 toward the edges there are accumulations of material, provided to prevent crack formation starting from the ends 122a, 123a, 124a, 125a, 126a, 127a of the slits toward the edges. Instead of the accumulations of material or in combination with such accumulations of material, holes with a circular cross section may be provided at the ends 122a, 123a, 124a, 125a, 126a, 127a of the slits toward the edges, extending through the membrane-like material of the valve 120 along the notch-like ends 122a, 123a, 124a, 125a, 126a, 127a of the slits and thereby taking away from the ends 122a, 123a, 124a, 125a, 126a, 127a of the slits their notch-like character, so that crack propagation caused by notch stresses in the membrane material of the valve 120 is prevented. The valve 120 resembles a circus tent with a tarpaulin lying on hanging-down beams, which is poorly tensioned and consequently sagging.

Onto each of the valves 90, 100, 110 or 120 (see FIGS. 13, 14, 15, 16) there may additionally be pushed a rigid stabilizing ring or clamping ring (not shown), the inside diameter of which is less than the outside diameter of a valve 90, 100, 110 or 120 without clamping and by which the valve 90, 100, 110 or 120 is compressed in the radial direction. The term “rigid” should be understood here in the sense that the flexibility of the stabilizing or clamping ring is much less than that of the valve. This gives the valve 90, 100, 110 or 120 a prestressing which, on account of the concavity of the valve flaps, brings about the effect of pressing these valve flaps against one another in the slits. This stabilizing ring, extending around the valve 90, 100, 110 or 120 in the circumferential direction, extends at least over a partial portion of the axial length of the valve 90, 100, 110 or 120.

It is particularly advantageous if this stabilizing ring is displaceable along the valve 90, 100, 110 or 120 along the axial direction. In the case of the valve 90, 100, 110 or 120 with concave valve flaps, a displacement of the stabilizing ring or clamping ring along the axial direction brings about a change in the prestressing in the valve material, and consequently a change in the pressing force of the valve flaps pressed against one another, and consequently ultimately a change in the closing force of the valve 90, 100, 110 or 120.

An axial displacement of the stabilizing ring in the flowing-through direction of the valve then brings about an increase in the closing force. An axial displacement of the stabilizing ring opposite to the flowing-through direction of the valve thereby brings about a reduction in the closing force.

In this way it is possible to create valves of an identical construction, the valve flaps of which are respectively subjected to prestressings of different magnitudes.

The valves 50, 60, 70, 80, 90, 100, 110, 120 described and shown here preferably consist of an elastomer material. For stabilizing or stiffening, stiffening ribs or stiffening meshes may be provided on the surfaces or within the valve material. In particular, woven fabric inserts may be used to prevent crack propagation or crack formation. Local valve stiffening is also possible by a locally different thickness of the sheet-like valve material, to be precise preferably in the form of surface ribs of valve material. The valves may be produced in one piece and also provided with an inherent material stress (“frozen-in” state of stress). Such inherent material stresses and/or a special valve form in which deformation, and in particular eversion, of the valve takes place along the plane of the sheet-like main body of the valve, while overcoming a compression of the valve, allow the valves according to the invention to be provided with pressure points.

A further exemplary embodiment of a valve 130 according to the invention is shown in FIGS. 17A and 17B. The valve flaps 133 are articulated on the valve body 131 as resilient or resiliently mounted elements. The valve flaps 133 may be produced from spring steel or a suitable plastic. As shown in FIG. 17A, in the pressureless state the valve flaps 133 lie against one another and close the valve opening, so that no material can flow out from inside the valve body 131. The valve flaps 133 may alternatively be arranged such that, in the closed state, they are under prestressing and seal the valve opening.

Serving for opening the valve 130 is a tappet 132, which presses the valve flaps 133 in the opening direction, so that, as shown in FIG. 17B, the valve flaps 133 move away from one another and release the valve opening.

For this purpose, either the tappet 132 may move in the direction of the valve flaps 133 or the valve body 131 is used as the tappet 132.

In the example shown here, the tappet 132 is formed as an annular tappet 132 with an inner channel 136.

The annular channel 136 may contain mass, which can only emerge from the channel 136 when the valve flaps 133 are opened.

Furthermore, further mass may be contained within the valve body 131, in the annular channel 137 surrounding the annular tappet 132, and can flow out of the valve 130 as soon as the valve flaps 133 are in the open position.

It may be provided, for example, that a first mass component is kept in the inner channel 136 and, separately from it, a second, different mass component is kept in the annular channel 137. These components may be delivered simultaneously through the valve 130 according to the invention. The first mass component may be a filling mass or particulate component, such as pieces of nut or cracknel.

If the tappet 132 is pulled back again and mass does not continue to flow, the inherent stress of the valve flaps 133 ensures that the valve flaps 133 resume the closed position, shown in FIG. 17A.

1-35. (canceled)

36. A casting machine valve, for installation in a casting machine, wherein the valve has a valve body with a valve opening and at least one valve flap, which is assigned to the valve opening and is articulated on the valve body, and the valve flap closes the valve opening in the pressureless state to the greatest extent without prestressing.

37. The casting machine valve as claimed in claim 36, wherein the valve is in an open state when a pressure gradient is present along the flowing-through direction of the said valve and in a closed state when this pressure gradient is not present along the flowing-through direction of the said valve.

38. The casting machine valve as claimed in claim 36, wherein the valve flap is flexible.

39. The casting machine valve as claimed in claim 36, wherein the valve flap consists of elastomer material, which lies against the valve opening.

40. The casting machine valve as claimed in claim 36, wherein the valve has at least two valve flaps assigned to the valve opening, articulated on the valve body and sealing the valve opening.

41. The casting machine valve as claimed claim 36, wherein the flap edge of the at least one valve flap of the valve, projected perpendicularly to the flowing-through direction of the valve onto a valve cross-sectional plane, extends from a first radially outer point of the valve cross-sectional plane over a radially central point of the valve cross-sectional plane to a second radially outer point of the valve cross-sectional plane.

42. The casting machine valve as claimed in claim 36, wherein the valve has at least three valve flaps assigned to the valve opening, articulated on the valve body in a peripheral region and sealing the valve opening, the valve having a pyramidal shape which is elevated in the direction of the flowing-through direction of the valve and the pyramidal faces of which are respectively formed by a valve flap, so that between two respective pyramidal faces adjacent to one another there respectively extends a valve slit from a radially outer point to the radial center.

43. The casting machine valve as claimed in claim 42, wherein the valve has three, four, five or six valve flaps and a respectively three, four, five or six-faced pyramidal shape.

44. The casting machine valve as claimed in claim 42, wherein the pyramidal faces, as seen from the tip of the pyramid, are each concavely shaped and formed by a respective concavely shaped valve flap, the concavity of which extends between the delimiting valve slits of the flap and the peripheral articulating region of the flap, or the pyramidal faces, as seen from the tip of the pyramid, are each convexly shaped and formed by a respective convexly shaped valve flap, the convexity of which extends between the delimiting valve slits of the flap and the peripheral articulating region of the flap.

45. The casting machine valve as claimed in claim 36, wherein the valve body and the at least one valve flap are formed in one piece.

46. The valve as claimed in claim 45, wherein the valve body and the at least one valve flap of the valve are formed as an elastomer molding.

47. The casting machine valve as claimed in claim 36, wherein the valve body and the at least one valve flap are connected to one another by a form-locking and/or force-locking plug-in connection.

48. The casting machine valve as claimed in claim 36, wherein the valve is coupled to a stabilizing element or stiffening element.

49. The casting machine valve as claimed in claim 48, wherein the valve body and/or the at least one valve flap is coupled to a stabilizing element or stiffening element.

50. The casting machine valve as claimed in claim 48, wherein the stabilizing element or stiffening element consists of a first material and the valve or the valve body and/or the at least one valve consists of a second material, the modulus of elasticity of the first material being greater than the modulus of elasticity of the second material.

51. The casting machine valve as claimed in claim 45, wherein the valve body is arranged in a valve seat which surrounds it in the manner of a ring and consists of the second material.

52. The casting machine valve as claimed in claim 36, wherein, on account of the deformation of the valve, during the transition from the closed state to the open state of the valve or during the transition from the open state to the closed state of the valve, the at least one valve passes through a pressure point at which the potential energy stored in the valve is at a maximum.

53. The casting machine valve as claimed in claim 52, wherein the deformation of the valve is an eversion of a valve flap from a concave form of the valve flap to a convex form of the valve flap or from a convex form of the valve flap to a concave form of the valve flap.

54. A pressure generating means for delivering a flowable mass (M), for installation in a casting machine (1), with a valve having a valve body with a valve opening and at least one valve flap, which is assigned to the valve opening and is articulated on the valve body, and the valve flap closes the valve opening in the pressureless state to the greatest extent without prestressing.

55. A pressure generating means comprising
a metering chamber with variable chamber volume and with at least one metering chamber outlet valve and one metering chamber inlet valve,
the metering chamber inlet valve being arranged in the fluidic connection between the mass container volume and the metering chamber volume, and
at least one outlet valve and one inlet valve each having a valve body with a valve opening and at least one valve flap assigned to the valve opening, articulated on the valve body and sealing the respective valve opening,
wherein the pressure generating means has valves with closing forces of different magnitude, in particular, the valve flap of the inlet valve and the valve flap of the outlet valve are subjected to prestressing of different magnitudes, pressing the valve flap against the valve opening.

56. The pressure generating means as claimed in claim 55, wherein at least one valve, in particular at least one inlet valve, has a valve body with a valve opening and at least one valve flap, which is assigned to the valve opening and is articulated on the valve body, and the valve flap closes the valve opening in the pressureless state to the greatest extent without prestressing

57. The pressure generating means as claimed in claim 55, wherein the flowing-through direction of the at least one metering chamber outlet valve extends from the metering chamber volume to the atmosphere surrounding the casting machine and in that the flowing-through direction of the metering chamber inlet valve extends from the mass container volume to the metering chamber volume.

58. The pressure generating means as claimed in claim 55, wherein a metering chamber has a plurality of metering chamber outlet valves and only one metering chamber inlet valve.

59. The pressure generating means as claimed in claim 55, wherein a metering chamber has a plurality of metering chamber outlet valves and a plurality of metering chamber inlet valves.

60. The pressure generating means as claimed in claim 59, wherein the number of metering chamber outlet valves and the number of metering chamber inlet valves of a metering chamber are the same.

61. The pressure generating means as claimed in claim 60, wherein each metering chamber outlet valve is assigned one metering chamber inlet valve.

62. The pressure generating means as claimed in claim 55, wherein it has a plurality of metering chambers.

63. The pressure generating means as claimed in claim 62, wherein each metering chamber has a metering chamber outlet valve and a metering chamber inlet valve.

64. The pressure generating means as claimed in claim 62, wherein the respective chamber volumes of each of the metering chambers are variable in a manner coupled to one another.

65. A casting machine for casting a flowable mass, with at least one valve as claimed in claim 36.

66. The casting machine as claimed in claim 65, wherein the casting machine has
a mass container for receiving the flowable mass;
at least one valve, which is in fluidic connection with the interior space of the mass container; and
a pressure generating means for producing a pressure gradient along the flowing-through direction of the valve.

67. The casting machine as claimed in claim 65, wherein the pressure generating means has a mass container which can be hermetically sealed and communicates with a pressure source.

68. The casting machine as claimed in claim 67, wherein the pressure source comprises a source for compressed gas, in particular a pressurized air source.

69. The casting machine as claimed in claim 66, wherein the pressure generating means has a hermetically sealable mass container with variable mass container volume.

70. The casting machine as claimed in claim 65, further comprising
a pressure generating means comprising a metering chamber with a variable chamber volume and with at least one metering chamber outlet valve and one metering chamber inlet valve,
the metering chamber inlet valve being arranged in the fluidic connection between the mass container volume and the metering chamber volume, and
at least one outlet valve and one inlet valve each having a valve body with a valve opening and at least one valve flap assigned to the valve opening, articulated on the valve body and sealing the respective valve opening,
wherein the pressure generating means has valves with closing forces of different magnitude, in particular, the valve flap of the inlet valve and the valve flap of the outlet valve are subjected to prestressing of different magnitudes, pressing the valve flap against the valve opening.
